(19) United States
(12) Patent Application Publication
(10) Pub. No.: US 2014/0220844 A1
(43) Pub. Date: Aug. 7, 2014

(54) Prepregs and Laminates Having Homogeneous Dielectric Properties

(71) Applicant: ISOLA USA CORP., Chandler, AZ (US)

(72) Inventors: Tarun Amla, Chandler, AZ (US); Johann R. Schumacher, Gilbert, AZ (US); Sascha Kreuer, Aachen (DE); Peggy Conn, Chandler, AZ (US); Stanley E. Wilson, Chandler, AZ (US)

(73) Assignee: ISOLA USA CORP., Chandler, AZ (US)

(21) Appl. No.: 13/803,698

(22) Filed: Mar. 14, 2013

Related U.S. Application Data
(60) Provisional application No. 61/761,669, filed on Feb. 6, 2013.

(51) Int. Cl. H01B 3/02

(52) U.S. Cl. CPC H01B 3/02
USPC 442/180; 524/413; 442/232; 427/385.5

(57) ABSTRACT

Resin compositions including one or more base resins and one or more high dielectric constant materials wherein the one or more high dielectric constant materials are present in the resin composition in an amount sufficient to impart the resin composition with a cured Dk that matches the Dk of the reinforcing material to which the resin composition is to be applied to within plus or minus (±) 15% as well as prepregs and laminates made using the resin compositions.

This application claims priority to U.S. provisional application No. 61/761669, filed on Feb. 6, 2013, the specification of which is incorporated herein in its entirety.

### BACKGROUND OF THE INVENTION

(1) Field of the Invention

This invention relates to resin compositions that include one or more high dielectric constant materials incorporated into a base resin wherein the high dielectric constant material has a dielectric constant that is greater than the dielectric constant of the cured base resin. This invention also relates to prepregs and laminates made with the resin compositions.

(2) Description of the Art

Prepregs and copper clad laminates are planar materials that are routinely used in the manufacture of printed circuit boards (PCGs). Prepregs and laminates are typically composite structures that include a reinforcing material such as woven glass, non-woven glass, paper, or other fibrous materials and a polymeric resin that is used as the matrix material—the material that is applied to or that is used to impregnate the reinforcing material

With operating frequencies of electronic devices ever increasing, the dielectric properties of the prepregs and laminates that are used to make PCBs are becoming more important to control. One problem with current prepregs and laminates is that the dielectric properties of the reinforcing materials and the matrix materials are very different. When very high speed signals are transmitted through structures such as printed circuit boards built using such metal clad laminates, the signal experiences skew and a difference in speed as the signal propagates over anisotropic regions. The problem is further compounded when a different signal is run and in a worst-case scenario, the difference in propagation speed over long lines leads to major signal integrity problems and in some cases to total signal disappearance. This problem has become a major concern for electronic device designers especially with onboard frequencies moving to 14 GHz to transmit 100 Gigabits/second over four channels in which the skew is expected to be a major design challenge.

### SUMMARY OF THE INVENTION

The present invention is directed to resins, prepregs and laminates that solve the skew problem by reducing or eliminating the gap between the dielectric constant of the resin composition matrix material and the dielectric constant of the reinforcing material(s). Thus, one aspect of this invention is a resin composition (or matrix material) comprising one or more base resins and one or more high dielectric constant materials wherein the one or more high dielectric constant materials are present in the resin composition in an amount sufficient to impart the resin composition with a cured Dk that matches the Dk of the reinforcing material to which the resin composition is applied to form a matrix to within plus or minus (±) 15%.

Another aspect of this invention are resin compositions comprising at least one base resin and from about 5 to about 60 wt % of particles of one or more high dielectric constant materials selected from the group consisting of strontium titanate, barium titanate, lead titanate, lead zirconate titanate, lead lanthanum zirconate titanate and combinations thereof wherein the Dk of the resin composition matches the Dk of a woven glass fabric reinforcing material to which the resin composition is applied to form a matrix to within plus or minus (±) 15%.

Still another aspect of this invention are prepregs comprising a matrix reinforcing material having a Dk_{R}, and a resin composition including one or more base resins having a Dk_{M} where Dk_{R} is more than 15% greater than Dk_{M}, the resin composition further including one or more high dielectric constant materials present in the resin composition in an amount sufficient to impart the resin composition with a cured Dk_{M} that matches the Dk_{R} of the reinforcing material to which the resin composition is applied to form a matrix to within plus or minus (±) 15% and more preferably plus or minus 5%.

Yet another aspect of this invention is a method of preparing a laminate comprising the steps of: preparing a resin composition including one or more base resins having a base resin dielectric constant; selecting a reinforcing material having a Dk_{R}; applying the resin composition to the reinforcing material and thereafter at least partially curing the resin to form a prepreg including a reinforcing material and a resin matrix; and before the applying step, adding a high dielectric constant material into the base in an amount sufficient to case a measurable increase in the dielectric constant of the prepreg—this in comparison to the dielectric constant of a prepreg made with the same resin composition but without the high dielectric constant material.

### DESCRIPTION OF CURRENT EMBODIMENTS

This invention is directed generally to resin matrix materials as well as to prepregs and laminates used in the electronics industry that include a resin matrix component and a reinforcing component where matrix component dielectric constant and the reinforcing material dielectric constant are made “homogeneous” by the addition of a high dielectric constant material to the resin matrix material. By “homogeneous” we mean that the matrix component dielectric constant (Dk_{M}) is within plus or minus (±) 15% of the reinforcing material dielectric constant (Dk_{R}) and more preferably to within ±5%.

The dielectric constant of the reinforcing material(s) (Dk_{R}) is generally constant for a particular type of reinforcing material. However, different reinforcing materials will have different Dk_{R}s. And even the same “type” of reinforcing materials such as woven glass can be made with different glass compositions that give the resulting material different Dk_{R}s. The dielectric constants of the matrix materials (Dkₘ) vary depending upon the matrix material recipes and are generally significantly different from and generally less than the dielectric constant of the reinforcing material (Dk_{R}). Therefore, one aspect of this invention is to provide a method for tuning the dielectric constant of the matrix material, by incorporating one or more high dielectric constant materials into a resin composition before the resin composition is applied as a matrix to a reinforcing material.

The “dielectric constants” discussed herein and the dielectric constant ranges or numbers referred to herein are all determined by the Bereskin test method or, in the alternative, by the split post method.

The reinforcing material(s) useful in the prepregs and laminates may be any sheet or ground up material that is known to be useful in manufacturing prepreg and laminate sheets for use for example in fabricating printed circuit boards. While ground up materials such as ground glass fiber materials may be used to form prepregs and laminates, it is preferred that the reinforcing material is a sheet material. For example, the reinforcing sheet material may be an inorganic fiber doth which would include but is not limited to glass doth (e.g., roving doth, cloth, a chopped mat, and a surfacing mat), metal fiber cloth, and the like; woven or unwoven cloth made of liquid crystal fiber (e.g., wholly aromatic polyamide fiber, wholly aromatic polyester fiber, and polybenzazole fiber); woven or unwoven cloth made of synthetic fiber (e.g., polyvinyl alcohol fiber, polyester fiber, and acrylic fiber); natural fiber cloth (e.g., cotton cloth, hemp cloth, and felt); carbon fiber cloth; and natural cellulosic cloth (e.g., craft paper, cotton paper, and paper-glass combined fiber paper).

In one aspect of the invention, the reinforcing material is a woven glass sheet material. Such woven glass materials will typically have a Dk_{R} of from about 3.5 to 7.0 or greater. Examples of such woven glass sheet materials include, for example, low Dk glass (e.g., 106 glass) having a Dk_{R} of from about 3.5 to about 4.5, E-glass; R-glass, ECR-glass, S-glass, C-glass, Q-glass and any other woven glass fabric of the kind known to be useful in preparing glass fabric reinforced prepregs and laminates.

The resin compositions of this invention will include one or more base resins that are known in the art to be useful in manufacturing prepreg and laminate materials. The base resin will typically be a thermoset or thermoplastic resin. Non-limiting examples of useful base resins include epoxy resins, cyanurate resins, bismaleimide resins, polyimide resins, phenolic resins, furan resins, xylene formaldehyde resins, ketone formaldehyde resins, urea resins, melamine resins, aniline resins, alkyd resins, unsaturated polyester resins, diallyl phthalate resins, triallyl cyanurate resins, triazine resins, polyurethane resins, silicone resins and any combination or mixture thereof.

In one aspect of this invention, the base resin is or includes an epoxy resin. Some examples of useful epoxy resins include phenol type epoxy resins such as those based on the diglycidyl ether of bisphenol A, on polyglycidyl ethers of phenol-formaldehyde novolac or cresol-formaldehyde novolac, on the triglycidyl ether of tris(p-hydroxyphenol)methane, or on the tetraglycidyl ether of tetraphenylethane; amine types such as those based on tetraglycidyl-methylenedianiline or on the triglycidyl ether of p-aminoglycol; cycloaliphatic types such as those based on 3,4-epoxycyclohexylmethyl-3, 4-epoxycyclohexane carboxylate. The term “epoxy resin” also stands for reaction products of compounds containing an excess of epoxy (for instance, of the aforementioned types) and aromatic dihydroxy compounds. These compounds may be halogen-substituted. Preference is given to epoxy-resins which are derivative of bisphenol A, particularly FR-4. FR-4 is made by an advancing reaction of an excess of bisphenol A diglydicyl ether with tetrabromobisphenol A. Mixtures of epoxy resins with bismaleimide resin, cyanate resin and/or bismaleimide triazine resin can also be applied.

The resin compositions, in addition to the base resin will typically include initiators or catalysts, one or more optional flame retardants and solvents. The flame retardant may be any flame retardant material that is known to be useful in resin compositions used to manufacture prepregs and laminates use to manufacture printed circuit boards. The flame retardant(s) may contain halogens or they may be halogen free. Alternatively, or in addition, the resins may include halogens such as bromine in their backbone structure to impart the cured resin with flame retardant properties.

The resin composition may also include polymerization initiators or catalysts. Examples of some useful initiators or catalysts include, but are not limited to peroxide or azo-type polymerization initiators (catalysts). In general, the initiators/catalysts chosen may be any compound that is known to be useful in resin synthesis or curing whether or not it performs one of these functions.

The resin composition will include one or more solvents which are typically used to solubilize the appropriate resin composition ingredients and/or to control resin viscosity and/or in order to maintain the resin ingredients in a suspended dispersion. Any solvent known by one of skill in the art to be useful in conjunction with thermosetting resin systems can be used. Particularly useful solvents include methylethylketone (MEK), toluene, dimethylformamide (DMF), or mixtures thereof. As noted below, the resin compositions are used to manufacture prepregs and laminates. During the manufacturing process, the reinforcing materials are impregnated with or otherwise associated with the resin compositions and some or most of the solvent is removed from the resin compositions to form the prepregs and laminates. Thus, when resin composition or laminate weight percent amounts are listed herein, they are reported on a dry-solvent free-basis unless otherwise noted.

The resin compositions may include a variety of other optional ingredients including fillers, tougheners, adhesion promoters, defoaming agents, leveling agents, dyes, and pigments. For example, a fluorescent dye can be added to the resin composition in a trace amount to cause a laminate prepared therefrom to fluoresce when exposed to UV light in a board shop's optical inspection equipment. Other optional ingredients known by persons of skill in the art to be useful in resins that are used to manufacture printed circuit board laminates may also be included in the resin compositions of this invention.

The resin compositions of this invention will also include one or more high dielectric constant materials. The high dielectric constant materials can be any materials that can be combined with a liquid base resin in amounts that allow the resulting resin composition to still be useful as a prepreg and laminate matrix material and that impart the cured or partially cured resin composition including the high dielectric material with a DK_{M} that is different from and preferably higher than the dielectric constant of a the partially or fully cured base resin. In one embodiment, the high dielectric constant material will have a Dk of greater than about 200 and more preferably greater than about 500.

One class of useful high dielectric constant materials are ferroelectric materials. Some useful ferroelectric materials include strontium titanate, barium titanate, lead titanate, lead zirconate titanate, lead lanthanum zirconate titanate and combinations thereof. Particularly useful high dielectric constant materials are strontium titanate and barium titanate.

The one or more high dielectric constant materials can be incorporated into the resin compositions as a particulate material. If a particulate high dielectric constant material is used, then it can have any useful particle size and more particularly a particle size ranging from about 1 nm to 40 microns.

The high dielectric constant material can be added to the base resin in any amount that produces a useful resin composition and/or partially or fully cured matrix material. In one embodiment, the high dielectric constant material can be incorporated into the resin composition in an amount sufficient to form a homogeneous prepreg or laminate. A “homogeneous” prepreg or laminate will have a Dk_{M} that is within ±15% of the reinforcing material Dk_{R} and preferably within ±5%.

The amount of high dielectric constant material that is incorporated into the resin composition will vary depending upon the dielectric constant of the base resin and the DK_{R} of the reinforcing material and in particular the difference between the two. Generally, the greater the difference between the dielectric constant of the base resin and the dielectric constant of the reinforcing material the greater the amount of high dielectric constant material that will be included in the resin composition. Generally, an amount of high dielectric constant material that is greater than about 2 wt % of the resin composition on a dry basis is necessary to cause a measurable change in the Dk_{M} in comparison to the base resin dielectric constant. The maximum amount of high dielectric constant material that can be incorporated into the resin composition without significantly impacting resin composition properties is about 70 wt % on a dry, solvent free basis. In an alternate embodiment the high dielectric constant material will be present in the resin composition in an amount ranging from about 5 to about 60 wt % on a dry basis. We have discovered that adding from about 5 to about 60 wt % of particulate barium titanate to a base resin having a Dk of about 4 increases the Dk_{M} of the resulting matrix from just above 4 at a 5 wt % loading to higher than 7.5 at a 60 wt % loading.

The resin compositions described above are especially useful for preparing prepregs and/or laminates used in the manufacture of printed circuit boards. In order to be useful in manufacturing printed circuit boards the laminates can be partially cured or b-staged—to form what is known in the industry as a prepreg—in which state they can be laid up with additional material sheets to form a c-staged or fully cured laminate sheet. Alternatively, the resins can be directly manufactured into c-staged or fully cured material sheets.

In one useful processing system, the resin composition/reinforcing material combinations described above are useful for making prepregs in batch or in continuous processes. Prepregs are generally manufactured using a reinforcing material or “core” material such as a roll of woven glass web (fabric) which is unwound into a series of drive rolls. The web then passes into a coating area where the web is passed through a tank which contains a thermosetting resin composition of this invention, solvent and other components where the glass web becomes saturated with the resin composition. The saturated glass web is then passed through a pair of metering rolls which remove excess resin from the saturated glass web and thereafter, the resin coated web travels the length of a drying tower for a selected period of time until the solvent is evaporated from the web. A second and subsequent coating of resin can be applied to the web by repeating these steps until the preparation of the prepreg is complete whereupon the prepreg—comprising a resin matrix and reinforcing material core is wound onto roll As noted above, the woven glass web can replaced with a woven fabric material, paper, plastic sheets, felt, and/or particulate materials such as glass fiber particles or particulate materials.

In another process for manufacturing prepreg or laminate materials, thermosetting resins of this invention are premixed in a mixing vessel under ambient temperature and pressure. The viscosity of the pre-mix is ˜600-1000 cps and can be adjusted by adding or removing solvent from the resin composition. A fabric substrate reinforcing material—such as E glass—is pulled through a dip tank including the premixed resin, through an oven tower where excess solvent is driven off and the prepreg is rolled or sheeted to size, layed up between Cu foil in various constructions depending on glass weave style, resin content and thickness requirements.

The resin composition can also be applied in a thin layer to a Cu foil substrate (RCC—resin coated Cu) using slot-die or other related coating techniques.

The resins, prepregs and resin coated copper foil sheets described above can be used to make laminates, such as those used to manufacture printed circuit boards, in batch or in continuous processes. In exemplary continuous process for manufacturing laminates of this invention, a continuous sheet in the form of each of copper, a resin prepreg and a thin fabric sheet are continuously unwound into a series of drive rolls to form a layered web of fabric, adjacent to the resin prepreg sheet which is adjacent to a copper foil sheet such that the prepreg sheet lies between the copper foil sheet and the fabric sheet The web is then subjected to heat and pressure conditions for a time that is sufficient to cause the resin composition to migrate into the fabric material and to completely cure the resin. In the resulting laminate, the migration of the resin composition into the fabric causes the thickness of the resin layer (the distance between the copper foil material and the fabric sheet material to diminish and approach zero as combination layers discussed above transforms from a web of three layers into a single laminate sheet. In an alternative to this method, a single prepreg resin sheet of this invention can be applied to one side of the fabric material layer and the combination sandwiched between two copper layers after which heat and/or pressure is applied to the layup to cause the resin material to flow and thoroughly impregnate the fabric layer and cause both copper foil layers to adhere to the central laminate.

In still another embodiment, resin composition coated copper sheets can be made at the same time the laminate is being made by applying a thin coating of resin to two different continuously moving copper sheets, removing any excess resin from the sheets to control the resin thickness and then partially curing the resin under heat and/or pressure conditions to form a sheet of b-staged resin coated copper. The sheet(s) of b-staged resin coated copper can then be used directly in the laminate manufacturing process.

In yet another embodiment, the fabric material—with or without prior pretreatment—can be continuously fed into a resin composition bath such that the fabric material becomes impregnated with the resin composition. The resin composition can be optionally partially cured at this stage in the process. Next, one or two copper foil layers can be associated with the first and/or second planar surface of the resin composition impregnated fabric sheet to form a web after which heat and/or pressure is applied to the web to fully cure the resin composition.

### EXAMPLES

A first laminate was made using a low dielectric constant woven glass cloth material which typically have a Dk_{R} ranging from 3.8 to 4.5. In particular, a resin composition was prepared by combining 85 wt % FR408 resin manufactured by Isola USA Corp. and 15 wt % solid particulate barium titanate both on a dry basis. The resin composition was used to impregnate a sheet of 106 Glass after which the resin composition impregnated glass cloth sheet was cured. The resulting cured sheet included about 74 wt % resin composition and 25 wt % woven glass cloth on a dry basis and had a delectric constant of 3.77. The dielectric constant is much higher than the dielectric constant of 3.22 which would be expected of a cured sheet made from a low DK Glass and FR408 base resin or a dielectric constant of 3.4 which would be expected of a cured sheet made from a low DK glass reinforcing material and FR408 base resin.

A second laminate was made following the same steps used to make the first laminate except that the resin composition used to impregnate the second laminate included 80 wt % FR408 resin and 20 wt % barium titanate. Also, a low dielectric constant glass with a dielectric constant in the range of 3.8-4.5 was used as reinforcement. 106 Glass style was used and a 75% resin content was achieved in the resulting cured sheet. After curing, the sheet had a delectric constant of 4.15 which is very close to the dielectric constant of the 106 glass cloth. This means that the resin matrix DK_{M} is very close (within plus or minus 15%) of the DK_{R}. Laminates made of such cured sheets would be very suitable for mitigating skew in high speed digital propagation and in other types and modes of electromagnetic signal propagation.

The invention has been described in an illustrative manner. It is to be understood is that the terminology, which has been used, is intended to be in the nature of words of description rather than limitation. Many modifications and variations of the invention are possible in light of the above teachings. Therefore, within the scope of the appended claims, the invention may be practiced other than as specifically described.

1. A resin composition comprising one or more base resins and one or more high Dk materials wherein the one or more high Dk materials are present in the resin composition in an amount sufficient to impart the resin composition with a cured Dk that matches the Dk of the reinforcing material to which the resin composition is applied to within plus or minus (±) 15%.

2. The resin composition of claim 1 wherein the one or more high Dk materials each have a Dk of at least about 500.

3. The resin composition of claim 1 wherein the one or more high Dk materials are particulate materials.

4. The resin composition of claim 3 wherein the one or more high Dk material particle size ranges from about lnm to about 40 microns.

5. The resin composition of claim 1 wherein the one or more high Dk materials are ferroelectric materials.

6. The resin composition of claim 5 wherein the ferroelectric materials are selected from the group consisting of strontium titanate, barium titanate, lead titanate, lead zirconate titanate, lead lanthanum zirconate titanate and combinations thereof.

7. The resin composition of claim 1 wherein the base resin is a thermoset or thermoplastic resin.

8. The resin composition of claim 1 wherein one or more high Dk materials are present in the composition in an amount ranging from about 2 to about 70 wt %.

9. The resin composition of claim 1 wherein the reinforcing material is selected from the group consisting of woven glass cloth, paper, felt, glass fibers, and plastic sheets.

10. The resin composition of claim 9 wherein the reinforcing material is a low Dk glass fabric sheet.

11. The resin composition of claim 10 wherein the low Dk glass fabric sheet has a Dk ranging from about 3.5 to about 7.0.

12. A resin composition comprising at least one base resin and from about 5 to about 60 wt % of particles of or more high Dk materials selected from the group consisting of strontium titanate, barium titanate, lead titanate, lead zirconate titanate, lead lanthanum zirconate titanate and combinations thereof wherein the Dk of the resin composition matches the Dk of a woven glass fabric reinforcing material to which the resin composition is applied to within plus or minus (±) 15%.

13. A prepreg comprising:
a reinforcing material having a Dk_{R} of from about 3.5 to about 4.5; and
a resin composition including one or more base resins having a Dk_{W} where Dk_{R} is more than 15% greater than Dk_{W} the resin composition further including one or more high Dk materials present in the resin composition in an amount sufficient to impart the resin composition with a cured Dk_{W} that matches the Dk_{R} of the reinforcing material to which the resin composition is applied to within plus or minus (±) 15%.

14. The prepreg of claim 13 wherein the one or more high Dk materials each have a Dk of at least about 500.

15. The prepreg of claim 13 wherein the one or more high Dk materials are particulate materials.

16. The prepreg of claim 15 wherein the one or more high Dk material particle size ranges from about lnm to about 40 microns.

17. The prepreg of claim 13 wherein the one or more high Dk materials are ferroelectric materials.

18. The prepreg of claim 17 wherein the ferroelectric materials are selected from the group consisting of strontium titanate, barium titanate, lead titanate, lead zirconate titanate, lead lanthanum zirconate titanate and combinations thereof.

19. The prepreg of claim 13 wherein the base resin is a thermoset or thermoplastic resin.

20. The prepreg of claim 13 wherein one or more high Dk materials are present in the composition in an amount ranging from about 2 to about 70 wt %.

21. The prepreg of claim 13 wherein the reinforcing material is selected from the group consisting of woven glass cloth, paper, felt, glass fibers, and plastic sheets.

22. The prepreg of claim 21 wherein the reinforcing material is a low Dk glass fabric sheet.

23. (canceled)

24. A prepreg of claim 13 wherein the reinforcing material is a woven glass fabric sheet and wherein the resin composition includes from about 5 to about 60 wt % of particles of one or more high Dk materials selected from the group consisting of strontium titanate, barium titanate, lead titanate, lead zirconate titanate, lead lanthanum zirconate titanate and combinations thereof.

25. A laminate including a prepreg of claim 13.

26. The laminate of claim 25 including at least one copper layer.

27. A printed circuit board including as at least one layer, the fully cured prepreg of claim 13.

28-30. (canceled)
